(19) United States
(12) Patent Application Publication
(10) Pub. No.: US 2020/0298400 A1
(43) Pub. Date: Sep. 24, 2020

(54) CONTROL SYSTEM AND CONTROL METHOD OF MANIPULATOR

(71) Applicants: Tyco Electronics (Shanghai) Co. Ltd., Shanghai (CN); TE Connectivity Corporation, Berwyn, PA (US)

(72) Inventors: Zongjie Tao, Shanghai (CN); Dandan Zhang, Shanghai (CN); Roberto Francisco-Yi Lu, Bellevue, WA (US)

(73) Assignees: Tyco Electronics (Shanghai) Co. Ltd., Shanghai (CN); TE Connectivity Corporation, Berwyn, PA (US)

(21) Appl. No.: 16/894,136

(22) Filed: Jun. 5, 2020

Related U.S. Application Data
(63) Continuation of application No. PCT/EP2018/083461, filed on Dec. 4, 2018.

(30) Foreign Application Priority Data
Dec. 7, 2017 (CN) 201711285789

(51) Int. Cl. B25J 9/16; B25J 9/00; B25J 19/02; G06N 3/06

(52) U.S. Cl. CPC B25J 9/161; B25J 9/163; G06N 3/06; B25J 9/0081; B25J 19/023; B25J 9/1653

(57) ABSTRACT

A control system for a manipulator includes a position indicator provided on a flange for mounting a tool of the manipulator, a position detector provided near the manipulator and configured to detect a position information of the position indicator in real time, a computer calculating a position data of the position indicator in real time according to the position information, a cloud server calculating a working parameter of a joint of the manipulator in real time by an artificial intelligence neural network according to the position data, and a controller controlling the joint in real time based on the working parameter. The artificial intelligence neural network is a self-learning neural network that calculates and automatically adjusts a weight among a plurality of neurons based on the position data.

### CROSS-REFERENCE TO RELATED APPLICATIONS

This application is a continuation of PCT International Application No. PCT/EP2018/083461, filed on Dec. 4, 2018, which claims priority under 35 U.S.C. § 119 to Chinese Patent Application No. 201711285789.X, filed on Dec. 7, 2017.

### FIELD OF THE INVENTION

The present invention relates to a control system and, more particularly, to a control system for a manipulator.

### BACKGROUND

In order to improve the working precision of a manipulator, each arm of the manipulator generally has a very high stiffness, so that there will be no elastic deformation error in each arm of the manipulator. Thereby, special metal is often used to ensure the rigidity of the arm, which increases the weight and cost of the entire manipulator. In addition, in order to ensure the working precision of the manipulator, it is required that a transmission gear in each joint of the manipulator has very high precision, and a tooth gap between the transmission gears is very small. Moreover, other components of the manipulator should also have high precision, which also increases the cost.

The traditional rigid manipulator is usually controlled by a control system with fixed kinematics parameters. However, the control system with fixed structural parameters is not suitable for an elastic manipulator because the elastic manipulator has a large elastic deformation error and the structural parameters of the elastic manipulator will change continuously.

### SUMMARY

A control system for a manipulator includes a position indicator provided on a flange for mounting a tool of the manipulator, a position detector provided near the manipulator and configured to detect a position information of the position indicator in real time, a computer calculating a position data of the position indicator in real time according to the position information, a cloud server calculating a working parameter of a joint of the manipulator in real time by an artificial intelligence neural network according to the position data, and a controller controlling the joint in real time based on the working parameter. The artificial intelligence neural network is a self-learning neural network that calculates and automatically adjusts a weight among a plurality of neurons based on the position data.

### BRIEF DESCRIPTION OF THE DRAWINGS

The invention will now be described by way of example with reference to the accompanying Figures, of which:

FIG. 1 is a schematic diagram of a control system for a manipulator according to an embodiment;

FIG. 2 is a schematic diagram of a process of moving the manipulator by a manual teaching method; and

FIG. 3 is an illustrative simple schematic model of an artificial intelligence neural network.

### DETAILED DESCRIPTION OF THE EMBODIMENT(S)

Exemplary embodiments of the present disclosure will be described hereinafter in detail with reference to the attached drawings; wherein like reference numerals refer to like elements. The present disclosure may, however, be embodied in many different forms and should not be construed as being limited to the embodiments set forth herein; rather; these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

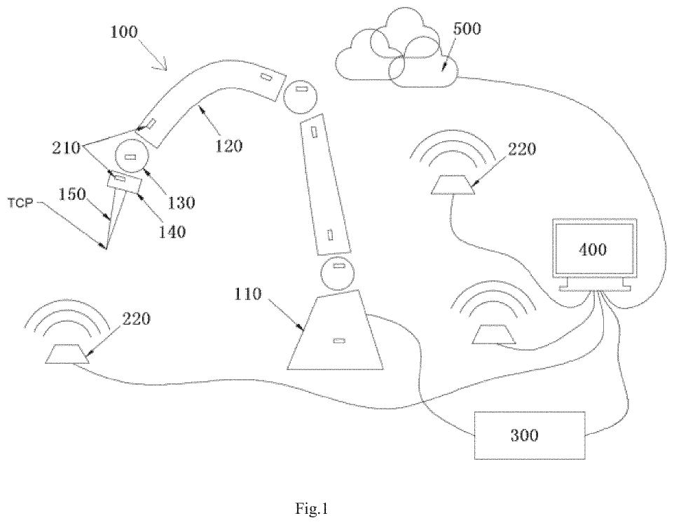

A control system for a manipulator according to an embodiment, as shown in FIG. 1, comprises at least one position indicator 210, a position detector 220, a controller 300, a computer 400, and a cloud server 500.

As shown in FIG. 1, in an embodiment, the at least one position indicator 210 is provided on a flange 140 for mounting a tool 150 of the manipulator 100. The position detector 220 is provided near the manipulator 100 and configured to detect position information of the position indicator 210 in real time. The computer 400 is adapted to calculate a position data of the position indicator 210 in real time according to the detected position information. The cloud server 500 is adapted to calculate working parameters of each joint 130 of the manipulator 100 in real time by an artificial intelligence neural network according to the calculated position data. The working parameters may comprise a rotation angle, a rotation speed, and an acceleration of a driving motor provided at each joint 130 of the manipulator 100. The controller 300 is adapted to control each joint 130 in real time based on the calculated working parameters.

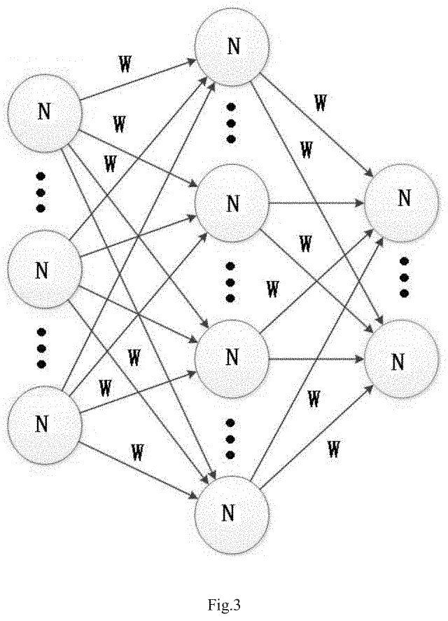

FIG. 3 shows an illustrative simple schematic model of an artificial intelligence neural network according to an exemplary embodiment of the present disclosure. As shown in FIG. 3, in an embodiment, the artificial intelligence neuron network is a self-learning neural network, which calculates and automatically adjusts a weight W between neurons N based on the input position data, so that the accommodation time, the steady-state error, and the trajectory error of the control system are minimal.

As shown in FIG. 1, in an embodiment, the position indicator 210 has an Ultra Wide Band (UWB) transmitter, the position detector 220 has an Ultra Wide Band receiver, and the position information includes a relative position of the Ultra Wide Band transmitter with respect to the Ultra Wide Band receiver obtained by the Ultra Wide Band receiver. The computer 400 is adapted to compute the position data of the position indicator 210 according to the relative position obtained by the Ultra Wide Band receiver. However, the present disclosure is not limited to this, for example, in another embodiment, the position indicator 210 may comprise a visual marker, the position detector 220 may comprise a camera, and the position information comprises an image of the visual marker captured by the camera. The computer 400 is adapted to process the image captured by the camera to obtain the position data of the position indicator 210.

In order to increase the amount of position data, as shown in FIG. 1, in an embodiment, at least one position indicator 210 is provided on a base 110, each arm 120, and each joint 130 of the manipulator 100.

In an embodiment, at least one arm 120 of the manipulator 100 is elastic, and the manipulator 100 has an elastic deformation error when subjected to a force. In an embodiment; the mechanical precision of the manipulator 100 is lower than a current industry design standard precision of a rigid manipulator. For example, the transmission gears of the manipulator 100 are allowed to have large tooth gaps, and the components of the manipulator 100 may have large dimensional errors. In this way, it may greatly decrease the cost of manufacturing the manipulator 100.

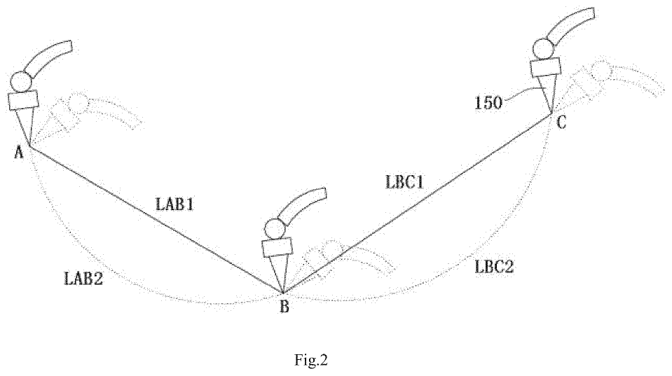

FIG. 2 shows a process of moving the manipulator shown in FIG. 1 by a manual teaching method according to an exemplary embodiment of the present disclosure. A method of controlling the manipulator 100 will be described with reference to FIGS. 1-3 according to an exemplary embodiment of the present disclosure. The method may comprise steps of:

S100: as shown in FIG. 1, providing the control system according to any one embodiment as mentioned above;

S200: as shown in FIGS. 1 and 2, controlling a tool center point TCP of the manipulator 100 by a manual teaching method to move the tool center point TCP from a first point A to a second point B along a plurality of different paths LAB1, LAB2, respectively, and calculating the position data of the position indicator 210 at the first point A and the second point B;

S300: as shown in FIGS. 2 and 3, inputting the calculated position data into the artificial intelligence neuron network operated on the cloud server 500, wherein the artificial intelligence neuron network calculates and automatically adjusts the weight W among neurons N based on the input position data so that the accommodation time, the steady-state error, and the trajectory error of the control system are minimal. The artificial intelligence neuron network improves the control accuracy of the control system.

As shown in FIG. 3, in an embodiment, only two paths LAB1, LAB2 are shown, But, it is appreciated for those skilled in this art, times that the manipulator 100 is moved from the first point A to the second point B should reach a certain amount, so that the weights W among the neurons N of the artificial intelligence neural network may be adjusted to the optimum, so as to minimize the accommodation time, the steady-state error and the trajectory error of the control system. Thereby, the times that the manipulator 100 is moved from the first point A to the second point B along the paths LAB1, LAB2, respectively, is usually not less than 10 times.

As shown in FIGS. 2-3, in an embodiment, the above method may further comprise steps of:

S400: controlling the tool center point TCP of the manipulator 100 by the manual teaching method to move the tool center point from the second point B to a third point C along a plurality of different paths LAC1, LAC2, respectively, and calculating the position data of the position indicator 210 at the second point B and the third point C;

S500: inputting the calculated position data into the artificial intelligence neuron network operated on the cloud server 500, wherein the artificial intelligence neuron network calculates and automatically adjusts the weight W among the neurons N based on the input position data so that the accommodation time, the steady-state error and the trajectory error of the control system are minimal.

As shown in FIGS. 2-3, in an embodiment, the above method may further comprise steps of:

S600: controlling the tool center point TCP of the manipulator 100 by the manual teaching method to move the tool center point from a current point to a next point along a plurality of different paths, respectively, and calculating the position data of the position indicator 210 at the current point and the next point;

S700: inputting the calculated position data into the artificial intelligence neuron network operated on the cloud server 500, wherein the artificial intelligence neuron network calculates and automatically adjusts the weight W among the neurons N based on the input position data so that the accommodation time, the steady-state error and the trajectory error of the control system are minimal.

As shown in FIGS. 2-3, in an embodiment, there are a plurality of key points in a working area of the manipulator 100, the key points at least comprises the first point A, the second point B, the third point C, the current point, and the next point. The above method may further comprise a step of:

S800: repeating the steps S600 and S700 until the manipulator 100 has been moved to all key points.

As shown in FIG. 2, in an embodiment, the posture of the tool 150 remains unchanged while the tool center point TCP of the manipulator 100 is moved from one point A to another point B along one path LAB1 or LAB2. The posture of the tool 150 while the tool center point TCP of the manipulator 100 is moved from one point A to another point B along one path LAB1 is different from the posture of the tool 150 while the tool center point TCP is moved from one point A to another point B along another path LAB2 different from the one path LAB1. But the present disclosure is not limited to this; in another embodiment, the posture of the tool 150 may be changeable while the tool center point TCP is moved from one point A to another point 13 along one path LAB1, LAB2.

As shown in FIG. 2, in an embodiment, the tool 150 mounted on the manipulator 100 are in an unloaded state without gripping any work piece in the above steps S100-S800.

In another embodiment, in order to enable the artificial intelligence neural network of the manipulator control system to adapt to a load state better, after completing the steps S100-S800, the tool 150 mounted on the manipulator 100 is in a load state of gripping a work piece; and the above method may further comprise a step of:

S900: repeating the steps S200 and S300.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle. Although several exemplary embodiments have been shown and described, it would be appreciated by those skilled in the art that various changes or modifications may be made in these embodiments without departing from the principles and spirit of the disclosure; the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A control system for a manipulator, comprising:
a position indicator provided on a flange for mounting a tool of the manipulator;
a position detector provided near the manipulator and configured to detect a position information of the position indicator in real time;
a computer calculating a position data of the position indicator in real time according to the position information;
a cloud server calculating a working parameter of a joint of the manipulator in real time by an artificial intelligence neural network according to the position data; and
a controller controlling the joint in real time based on the working parameter, the artificial intelligence neural network is a self-learning neural network that calculates and automatically adjusts a weight among a plurality of neurons based on the position data.

2. The control system of claim 1, wherein the self-learning neural network calculates and automatically adjusts the weight among the plurality of neurons to minimize an accommodation time, a steady-state error, and a trajectory error of the control system.

3. The control system of claim 1, wherein the position indicator is a visual marker, the position detector is a camera, and the position information is an image of the visual marker captured by the camera, the computer processes the image captured by the camera to obtain the position data.

4. The control system of claim 1, wherein the position indicator is an Ultra Wide Band transmitter, the position detector is an Ultra Wide Band receiver, and the position information is a relative position of the Ultra Wide Band transmitter with respect to the Ultra Wide Band receiver obtained by the Ultra Wide Band receiver, the computer computes the position data according to the relative position obtained by the Ultra Wide Band receiver.

5. The control system of claim 1, wherein the position indicator is disposed on a base, an arm, or the joint of the manipulator.

6. The control system of claim 1, wherein the manipulator has an arm that is elastic and the manipulator has an elastic deformation error when subjected to a force.

7. The control system of claim 1, wherein a precision of the manipulator is lower than a current industry design standard precision of a rigid manipulator.

8. The control system of claim 1, wherein the working parameter is a rotation angle, a rotation speed, and an acceleration of a driving motor at the joint.

9. A method of controlling a manipulator, comprising:
providing a control system including:
a position indicator provided on a flange for mounting a tool of the manipulator;
a position detector provided near the manipulator and configured to detect a position information of the position indicator in real time;
a computer calculating a position data of the position indicator in real time according to the position information;
a cloud server calculating a working parameter of a joint of the manipulator in real time by an artificial intelligence neural network according to the position data; and
a controller controlling the joint in real time based on the working parameter;
controlling a tool center point of the manipulator by a manual teaching method to move the tool center point from a first point to a second point along a plurality of different paths, and calculating the position data at the first point and the second point; and
inputting the position data into the artificial intelligence neural network, the artificial intelligence neural network is a self-learning neural network that calculates and automatically adjusts a weight among a plurality of neurons based on the position data.

10. The method of claim 9, wherein the self-learning neural network calculates and automatically adjusts the weight among the plurality of neurons to minimize an accommodation time, a steady-state error, and a trajectory error of the control system.

11. The method of claim 9, further comprising controlling the tool center point of the manipulator by the manual teaching method to move the tool center point from the second point to a third point along a plurality of different paths, and calculating the position data at the second point and the third point.

12. The method of claim 11, further comprising inputting the position data from the second point and the third point into the artificial intelligence neural network, the artificial intelligence neural network calculates and automatically adjusts the weight among the neurons based on the position data to minimize the accommodation time, the steady-state error, and the trajectory error of the control system.

13. The method of claim 12, further comprising controlling the tool center point of the manipulator by the manual teaching method to move the tool center point from a current point to a next point along a plurality of different paths, and calculating the position data at the current point and the next point.

14. The method of claim 13, further comprising inputting the position data from the current point and the next point into the artificial intelligence neural network, the artificial intelligence neural network calculates and automatically adjusts the weight among the neurons based on the position data to minimize the accommodation time, the steady-state error, and the trajectory error of the control system.

15. The method of claim 14, wherein the manipulator has a working area with a plurality of key points, the key points include the first point, the second point, the third point, the current point, and the next point, the controlling and inputting steps are repeated until the manipulator has been moved to all of the key points.

16. The method of claim 9, wherein a posture of the tool remains unchanged while the tool center point moves from the first point to the second point along a first path.

17. The method of claim 16, wherein the posture of the tool while the tool center point is moved from the first point to the second point along a second path is different from the posture along the first path.

18. The method of claim 9, wherein a posture of the tool is changeable while the tool center point moves from the first point to the second point along a first path.

19. The method of claim 15, wherein the tool is in an unloaded state without gripping any work piece in all of the controlling and inputting steps.

20. The method of claim 19, wherein the controlling and inputting steps are repeated with the tool in a load state gripping a work piece.
